(19) United States
(12) Patent Application Publication
(10) Pub. No.: US 2019/0184433 A1
(43) Pub. Date: Jun. 20, 2019

(54) MOBILE SYSTEM FOR FLUSHING ROADSIDE STRUCTURES

(71) Applicant: James P. Reed, Neversink, NY (US)

(72) Inventor: James P. Reed, Neversink, NY (US)

(21) Appl. No.: 15/847,849

(22) Filed: Dec. 19, 2017

(51) Int. Cl. B08B 3/02; B05B 1/20; B05B 1/30; B05B 9/00; B05B 9/04; B05B 12/00; B05B 13/00; B60Q 1/50

(52) U.S. Cl. CPC B08B 3/024; B05B 1/205; B05B 1/30; B05B 9/007; B05B 9/0403; B08B 2203/0276; B05B 13/005; B05B 15/08; B60Q 1/503; B08B 2203/0205; B08B 2203/027; B05B 12/006

(57) ABSTRACT

An improved system and method for spraying roadside structures comprising a motor vehicle equipped with a fluid tank, various spray devices including at least one upright spray bar positioned forward of the tank, a water pump, a water distribution system including distribution lines and solenoid valves for directing flow to desired spray devices, control panels in the cab for controlling the water pump and solenoid valves. The truck is equipped with a traffic safety signboard, emergency lights, and a controller in the cab for controlling said signboard and emergency lights.

### TECHNICAL FIELD

The present invention relates to a System and Method for Flushing Vertical Roadside Structures.

### BACKGROUND OF THE INVENTION

For routine maintenance, for special purposes, or otherwise, structures adjacent to highways, such as bridge sidewalls, railings and abutments, must be periodically cleaned or treated, such as, for example cleaning to flush away soluble salts, other contaminants, grit and other substances, or treating with salt neutralizers or sealants. One method of cleaning or treating such roadside structures may be by spraying (or “flushing”) them with pressurized water and/or chemical solutions. Current systems are cumbersome, inefficient, time-consuming, labor-intensive and hazardous. Current systems typically comprise a flusher truck with multiple hand-held hoses with a single spray nozzle on each hose. Each hose is operated by a separate crew member on foot outside the flusher truck, and the flusher truck remains stationary while crews are spraying. Then the flusher truck moves an incremental distance and stops while crew perform spraying there. This process may be repeated many times to clean roadside structures that span long distances. These current systems are slow moving and require the use of traffic cones and other traffic control devices. They may require trucks for carrying traffic cones, personnel for driving the cone trucks, and personnel for placing the cones. They may also require two or three flagmen for traffic control and safety. They also require a separate trailing vehicle equipped with road safety signals such as lane closure and merger signals. Therefore, the state-of-the-art is slow, equipment-intensive, manpower-intensive, disruptive of normal traffic flow, and a safety risk for the driving public and work crew.

There is a need for a system and method for flushing roadside structures that is faster, less equipment intensive, less manpower intensive, less disruptive of traffic, and safer.

The present invention is directed to an improved system and method for flushing roadside structures that meets these needs and overcomes the limitations of current systems. In a preferred embodiment, the present invention provides a truck equipped with a fluid tank, at least one vertically oriented spray bar positioned forward of the tank and proximate to the cab, a water pump, a hydraulic system for powering the water pump, a water distribution system, traffic safety signboard, emergency lights, and controllers such as control panels in the cab for controlling the hydraulic motor, water pump and valves of said water distribution system and for controlling said signboard and emergency lights. The improved system of the present invention reduces or eliminates the need to erect lane closure cones and barriers, and the need for operators on foot external to the cab, and the need for repeated stop, start and setup procedures. The improved system greatly reduces cleaning times, equipment costs, labor costs, traffic disruptions, and safety risks to work crew and the public. The improved system may reduce labor by 90% over current systems and can clean a structure in less than ten minutes that currently requires a crew of several people working all day. In addition, the improved system is effective on object surfaces that are out of reach of crew members on foot operating hoses, such as surfaces 15 feet high.

The present invention fills a desperate need for less expensive, more efficient, more effective, and faster ways of maintaining highway and bridge infrastructure in the United States, as infrastructure maintenance is presently a critical national priority and challenge.

The present invention has application for spraying, cleaning and treating any object accessible by motor vehicle, such as cleaning or treating other motor vehicles.

### SUMMARY OF THE INVENTION

In a first aspect, the present invention provides an apparatus for spraying roadside objects with fluid, comprising: a motor vehicle comprising a cab; a tank for holding a supply of fluid; a fluid pump for pumping the fluid; and a first spray device comprising a first upright spray bar attached to the vehicle for spraying fluid; wherein the first spray bar comprises a plurality of spaced apart spray outlets and a valve for controlling fluid flow to at least one of the plurality of outlets. In a second aspect, the present invention provides a method of spraying an object, comprising: propelling the apparatus just described alongside an object and simultaneously spraying fluid from the apparatus at the object.

In a third aspect, the present invention provides an apparatus for spraying roadside objects with fluid, comprising: a motor vehicle comprising a cab; a tank for holding a supply of fluid; a fluid pump for pumping the fluid; and a spray device comprising an upright spray bar for spraying fluid, said spray bar disposed forward of at least part of the tank; wherein said spray bar comprises a plurality of spaced apart spray outlets. In a fourth aspect, the present invention provides a method of spraying an object, comprising: propelling the apparatus just described alongside an object and simultaneously spraying fluid from the apparatus at the object.

In a fifth aspect, the present invention provides an apparatus for spraying roadside objects with fluid, comprising: a motor vehicle comprising a cab; a tank for holding a supply of fluid; a fluid pump for pumping the fluid; and a plurality of individually valved spray outlets spaced apart at different elevations for spraying the object. In a sixth aspect, the present invention provides a method of spraying an object, comprising: propelling the apparatus just described alongside an object and simultaneously spraying fluid from the apparatus at the object.

In a seventh aspect, the present invention provides an apparatus for spraying roadside objects with fluid, comprising an elongated conduit for carrying pressurized fluid flow; a plurality of individually valved spray outlets for spraying the object, said plurality of outlets spaced apart in the lengthwise direction of the conduit; wherein each valve of each of said plurality of outlets is independently operable.

In an eighth aspect, the present invention provides a method of spraying an object, comprising: providing a vehicle equipped with a plurality of individually selectable spray nozzles that are spaced apart at different elevations; selecting one or more of said spray nozzles; and propelling the vehicle alongside the object while simultaneously spraying fluid from the selected spray nozzles at the object.

### BRIEF DESCRIPTION OF THE DRAWINGS

The subject matter that is regarded as the invention is particularly pointed out and distinctly claimed in the concluding portion of the specification. The invention, however, may be best understood by reference to the following detailed description of various embodiments and the accompanying drawings in which:

FIG. 1 is a perspective view of one embodiment of the present invention;

FIG. 2 is another perspective view of the embodiment of FIG. 1;

FIG. 3 is a right side (passenger side) view of the embodiment of FIG. 1;

FIG. 4A is a front view of the embodiment of FIG. 1 shown spraying a roadside structure;

FIG. 4B is a depiction of the spray pattern on the object in FIG. 4A viewed from the nozzles;

FIG. 5 is a backside view of the embodiment of FIG. 1;

FIG. 6 is a rendering of one embodiment of the present invention with some features removed to expose other features that are otherwise hidden from view;

FIG. 7 is a front view of the embodiment of FIG. 1 with the addition of an overhead horizontal spray bar extension shown spraying a roadside structure;

FIG. 8 is a perspective view of a spray bar of the present invention;

FIG. 9A is a perspective view of an assembly of a slide-rail mount and spray bars of the present invention;

FIG. 9B is an exploded view of a spray bar mounting bracket assembly of the slide-rail mount of FIG. 9A;

FIG. 10A is a perspective view of the slide-rail mount of FIG. 9A;

FIG. 10B is a cross section view of the slide-rail mount of FIG. 10A;

FIG. 10C is an exploded view of a bolt and partial cross section view of the slide-rail mount of FIG. 10A taken through a bolt hole; and

FIG. 11 is a perspective view of a control panel of the present invention.

### DETAILED DESCRIPTION OF THE INVENTION

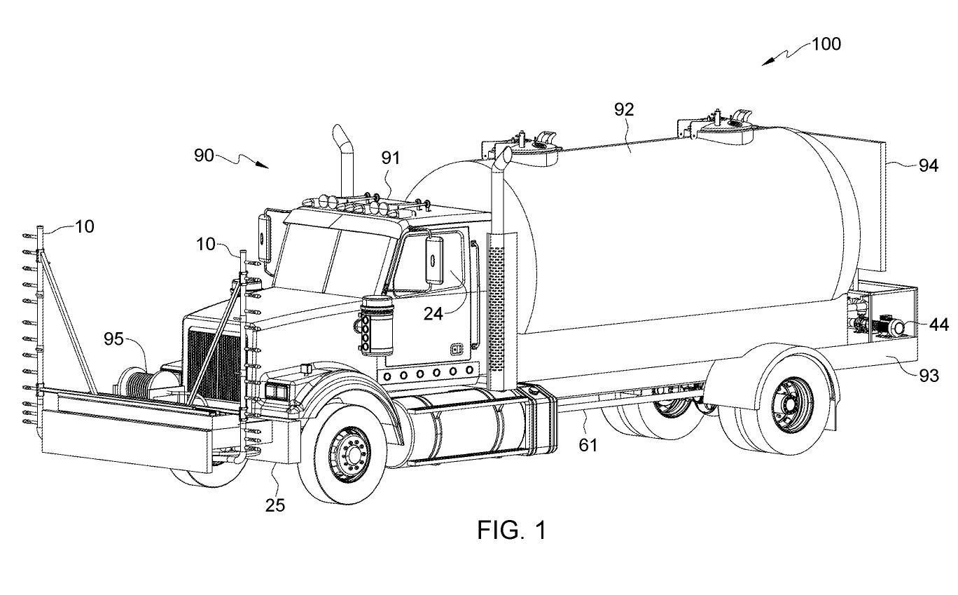

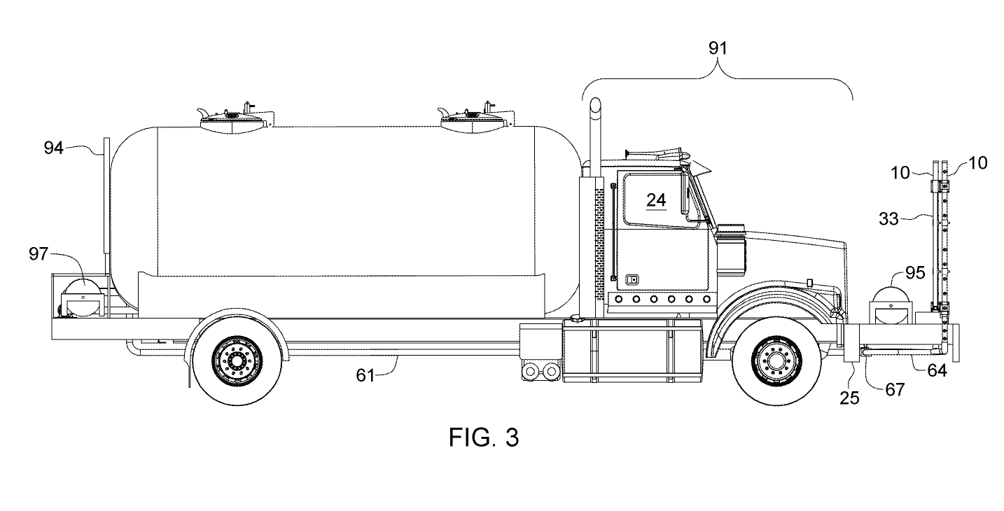

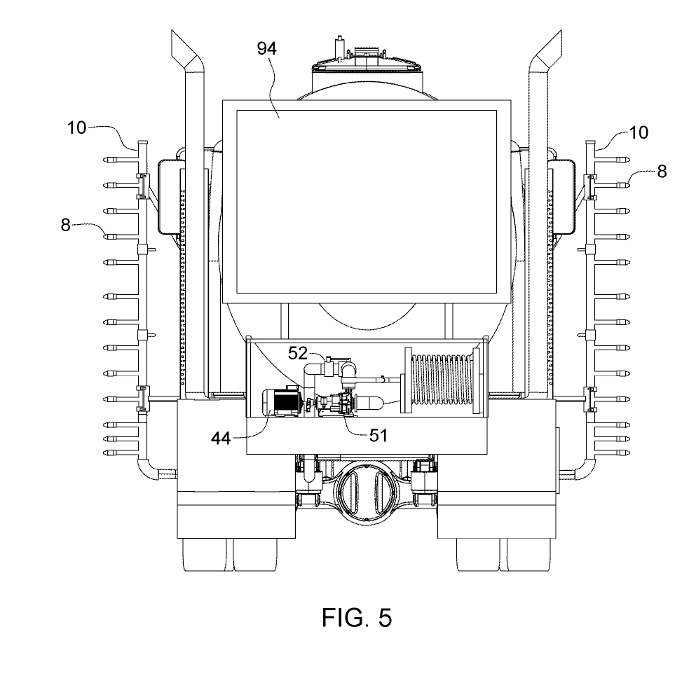

FIGS. 1-11 show a preferred embodiment of the flushing system of the present invention. The description herein describes the preferred embodiment of FIGS. 1-11 unless otherwise indicated.

For the purposes of this description, “driver side” and “passenger side” referred to the left side and right side, respectively, from the perspective of a driver of a vehicle facing forward. “Cab” as used herein comprises the compartment for housing the driver, controls and instrumentation needed for vehicle operations, and further comprises the engine compartment, hood and grille. “Spray device” as used herein may refer to a hose, spray bar, or other device for spraying fluids. In the preferred embodiment of FIGS. 1-11, spray devices comprise the front hose, rear hose, driver side spray bar, and passenger side spray bar. “Activate” as used herein may refer to being placed in use in spraying operations or being placed in a state of readiness for such use. “Outlet” or “spray outlet” as used herein may refer to a nozzle, orifice, port or other opening for providing a controlled release of spray from a pressurized water system. “Line”, “water line” or “distribution line” refers to a conduit such as a pipe, tube or hose suitable for carrying pressurized water. A line may be a network of interconnected lines, which network may have lines that branch off from other lines or from a common plenum. “Fluid” as used herein may refer to liquid fluids. In the description herein, water is the fluid medium, but the fluid medium is not limited to water. For example, the fluid may comprise other types of fluids, chemical solutions, detergent solutions, water based solutions and mixtures. “Traffic safety” or “traffic control” signals, information or messaging refers to signals, information or messaging directed to others in the vicinity of the spraying operation for safety or traffic control purposes. “Vehicle” or “motor vehicle” may be any self-propelled vehicle capable of operation on a roadway, and preferably a fully road worthy vehicle that meets all requirements for licensing and safe operation on public roadways.

With reference to FIG. 1, in a preferred embodiment, the improved flusher system 100 comprises a truck 90 equipped with cab 91 having side window 24 on each side, a front bumper 25 forward of the cab, a fluid tank 92, vertical spray bars 10, a water pump and distribution system for providing pressurized water to the spray bar, a hydraulic system for powering a hydraulic motor, which motor powers the water pump, a rear platform 93, and a traffic safety signboard 94. Preferably, the truck is fully road worthy and meets all requirements for licensing and safe operation on public roadways. Side windows 24 are adjacent to the driver and front passenger seat positions in the cab, and typically in the driver's door and front passenger's door.

Spray bars 10 may be vertical, i.e., oriented so that the bar's longitudinal axis is vertical and the outer surfaces of the side walls of the bar face outwardly from the axis, such as radially outward in a round tubular spray bar. “Vertical” and “upright” as used herein may include about vertical; 0-1° off vertical; 0-2° off vertical; 0-3° off vertical; 0-4° off vertical; 0-5° off vertical; 0-10° off vertical; 0-15° off vertical; 0-20° off vertical; 0-25° off vertical; 0-30° off vertical; 0-35° off vertical; 0-40° off vertical; and 0-45° off vertical.

Said hydraulic system for powering the hydraulic motor may comprise a hydraulic fluid reservoir, hydraulic pump connected to said reservoir with a hydraulic fluid line, a hydraulic motor connected to said pump with a hydraulic line, and a hydraulic flow control valve between the hydraulic pump and hydraulic motor. The hydraulic pump may be powered by a power takeoff (“PTO”) connected to the vehicle engine or transmission. In one embodiment, the PTO may be connected to the transmission and have a multiplier effect wherein the PTO output speed in rotations per minute (“rpm”) is faster than the rpm speed of the vehicle crankshaft. The speed of the hydraulic motor may be controlled by controlling the hydraulic flow control valve to regulate the amount of hydraulic fluid flow to the motor. The hydraulic motor speed may be controlled by an operator using a control panel in the cab of the vehicle.

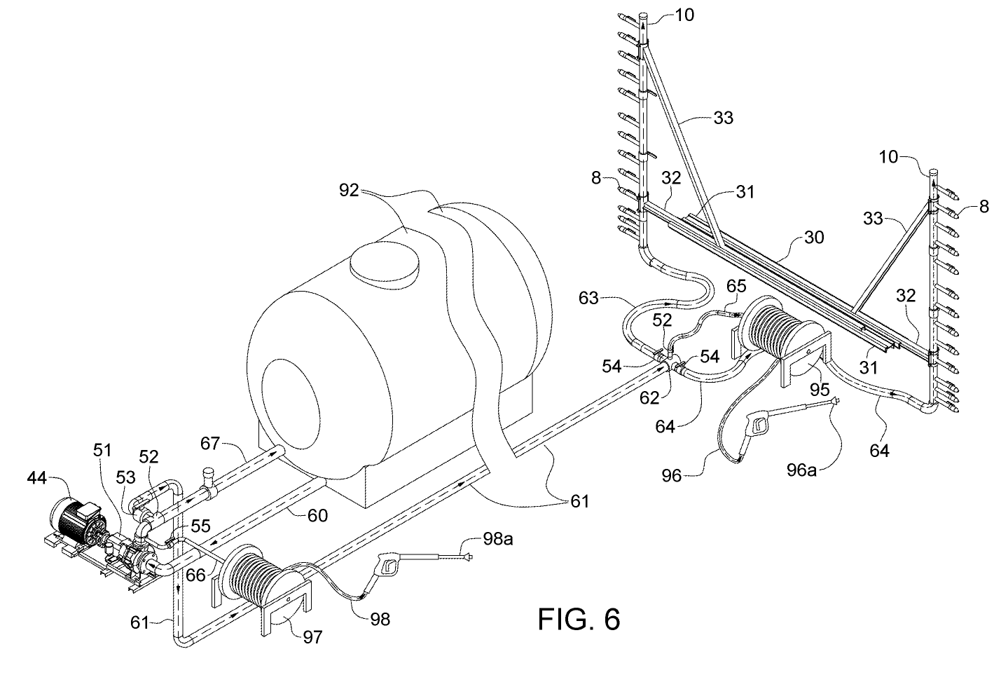

With reference to FIG. 6, the system may further comprise front hose 96, rear hose 98, or both, for manual operation to augment the spray bar flushing capabilities.

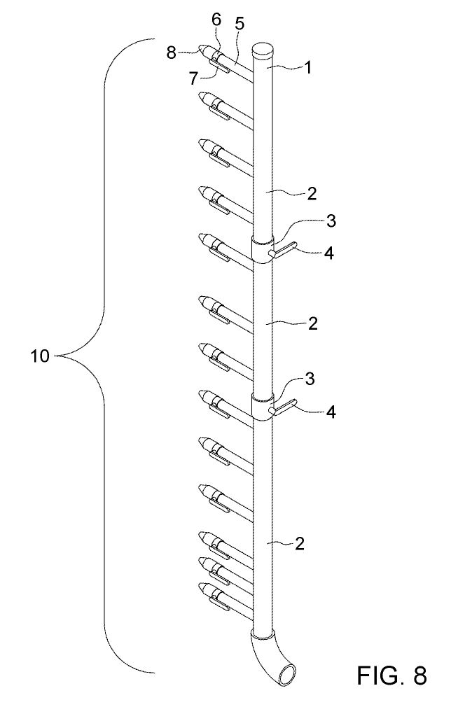

With reference to FIG. 8, in a preferred embodiment, spray bar 10 may comprise main tube 1 and multiple spray nozzles 8. In the preferred embodiment shown in FIG. 8, the main tube 1 is an elongated cylindrical tube disposed upright. In other embodiments, the main tube may have any suitable cross section shape and may be other than strait in the longitudinal direction, such as curved or bent. The nozzles may be connected to openings in the main tube with nozzle tubes 5. The nozzle tubes may be provided in any length. Spray bar 10 may further comprise nozzle valves 6 with manually operable valve handles 7 for closing, opening, or otherwise controlling the passage of fluid flow to each nozzle. A main tube opening may be considered to comprise the corresponding nozzle, and nozzle tube; and a nozzle connected to or disposed in the opening, nozzle or nozzle tube may be considered to be “connected” or “paired” to the opening.

With further reference to FIG. 8, main tube 1 may comprise two or more tube sections 2 connected together. Section connections may comprise a section valve 3 with section valve handle 4.

In a preferred embodiment, spray bar 10 may comprise brass components, may comprise brass tubing, may comprise brass nozzles, may comprise brass connections, and may comprise brass valves. Said items may comprise any suitable material.

Fluid flow to entire tube sections 2 may be controlled using tube section valves 3, and fluid flow to individual nozzles 8 may be controlled using nozzle valves 6. In a preferred embodiment, section valves 3 and nozzle valves 6 are quarter turn (¼ turn) valves.

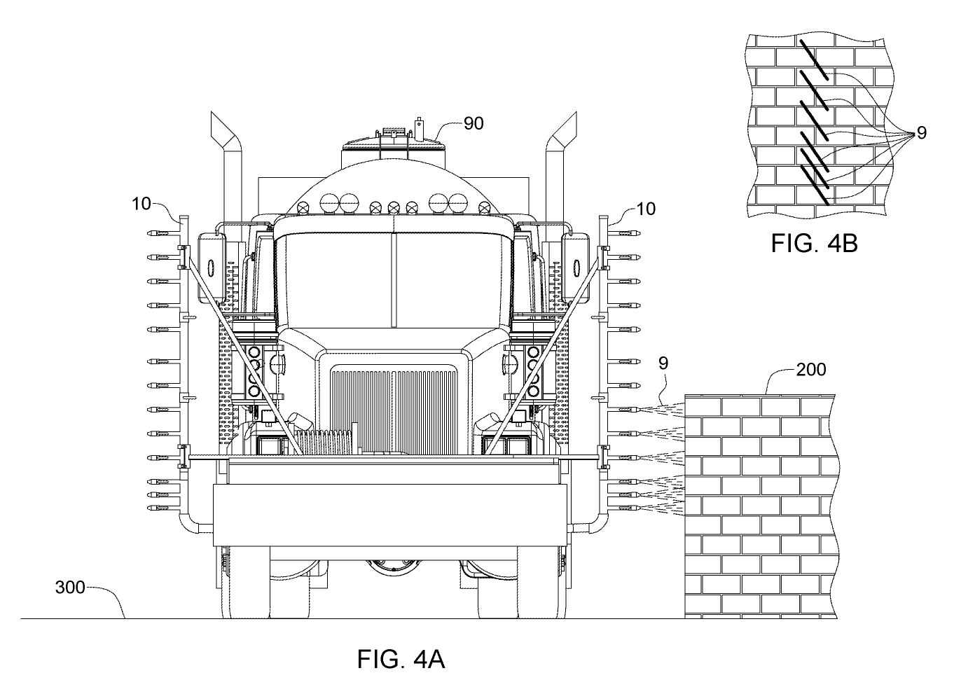

In a preferred embodiment, the main tube 1 may have a 2-inch diameter and the nozzle tubes 5 may have a ½-inch diameter. In a preferred embodiment, the spray bar 10 may be 68 inches long with the bottom three nozzles spaced apart at 3 inch increments and the remaining nozzles spaced apart in 6 inch increments. Spray bars may be provided in longer or shorter lengths, including, for example 15 feet long. A preferred embodiment, the nozzles are aimed laterally outward from the main tube. In other embodiments nozzles may be aimed in different directions and in different direction from one another. Nozzles 8 may have adjustable tips that may be adjusted to adjust the aim of the spray over a range of directions. In a preferred embodiment, one or more nozzles on the lower portion of the main tube may be aimed downwardly, for example straight down or at a downward angle. For example, with reference to FIG. 4A, the three lowermost nozzles on spray bar 10 may be aimed at a downward angle for purposes of spraying curbs and road surfaces, and may be configured to provide a wider angle spray fan than the other nozzles.

With reference to FIGS. 4A and 4B, in a preferred embodiment, nozzles 8 may be configured so as to create a flat, fan-shaped spray 9. Nozzles 8 may be vertically spaced apart and rotated axially so that spray fan 9 from each nozzle may vertically overlap the spray from each adjacent nozzle while the overlapping portion of adjacent spray fans remain laterally offset, such as, for example, the pattern shown in FIG. 4B wherein lines 9 represent where spray fans impinge upon object 200. Spray bar 10 may be provided with nozzles 8 of uniform design or may be provided with nozzles of a range of designs, such as, for example, spray shape may be uniform or may vary from one nozzle to the next.

In a preferred embodiment, a nozzle 8 may have a design flow rate range that comprises 12 gallons per minute (“gpm”). In a preferred embodiment, spray bar 10 may have thirteen nozzles and may have a design flow rate range that comprises 150 gpm-300 gpm when all nozzles are activated.

In a preferred embodiment, vertical spray bar 10 is configured and positioned so as to direct spray in an outward direction. In alternate embodiments, the spray bar may be configured and positioned so as to direct spray in any direction, and may be configured so as to direct spray in multiple directions simultaneously.

With further reference to FIGS. 6. 9A, 9B, and 10A-10C, in a preferred embodiment, spray bars 10 may be mounted on slide rail mounts 30. Slide rail mount 30 for the driver side spray bar may be connected to slide rail mount 30 for the passenger side spray bar. Slide rail mount 30 comprises guide rail 31, slide rail 32, and upright 33 extending upright from the slide rail. In a preferred embodiment, guide rail 31 may be attached to the truck chassis or frame forward of the cab. It may also be attached rearward of the cab. Slide rail 32 is slidably disposed in guide rail 31 and may be slid to any position between a fully retracted position and a fully extended position. In the fully retracted position, the outboard end of the slide rail is at its most inboard position, and in the fully extended position the outboard end of the slide rail is at its most outboard position. In one embodiment, the slide rail has a 36 inch range of motion so that the lateral position of the spray bar may be adjustable over a 36 inch range of motion and may be set to a desired position, ranging from positions inside the width of the truck and positions outside the width of the truck. In a preferred embodiment, spray bars 10 may extend up to about 16 inches outside the width of the truck.

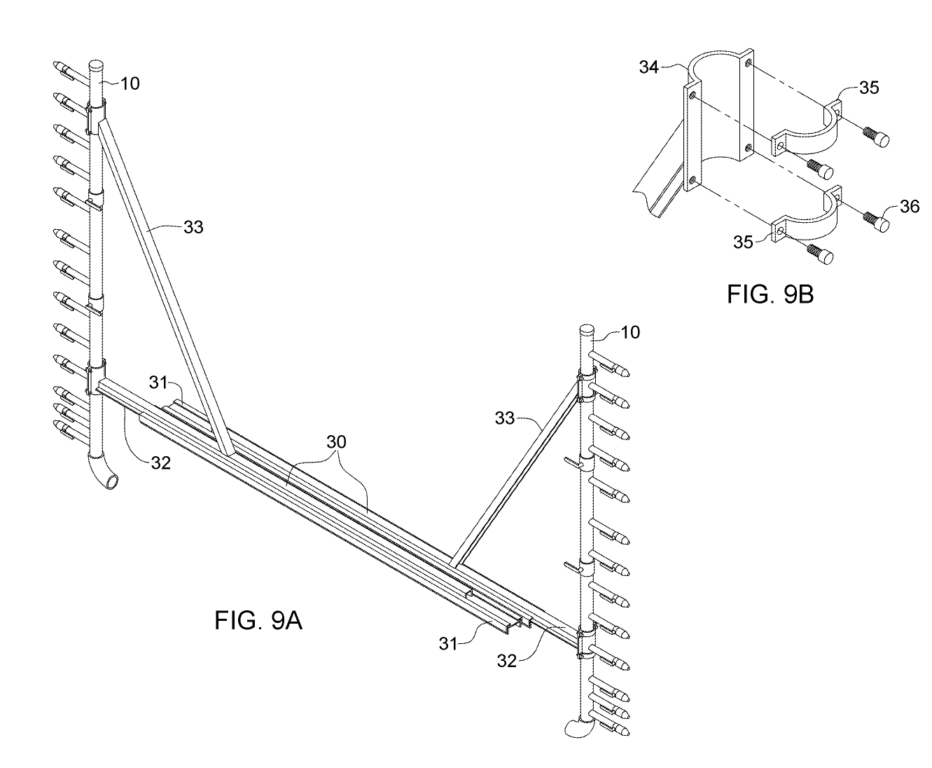

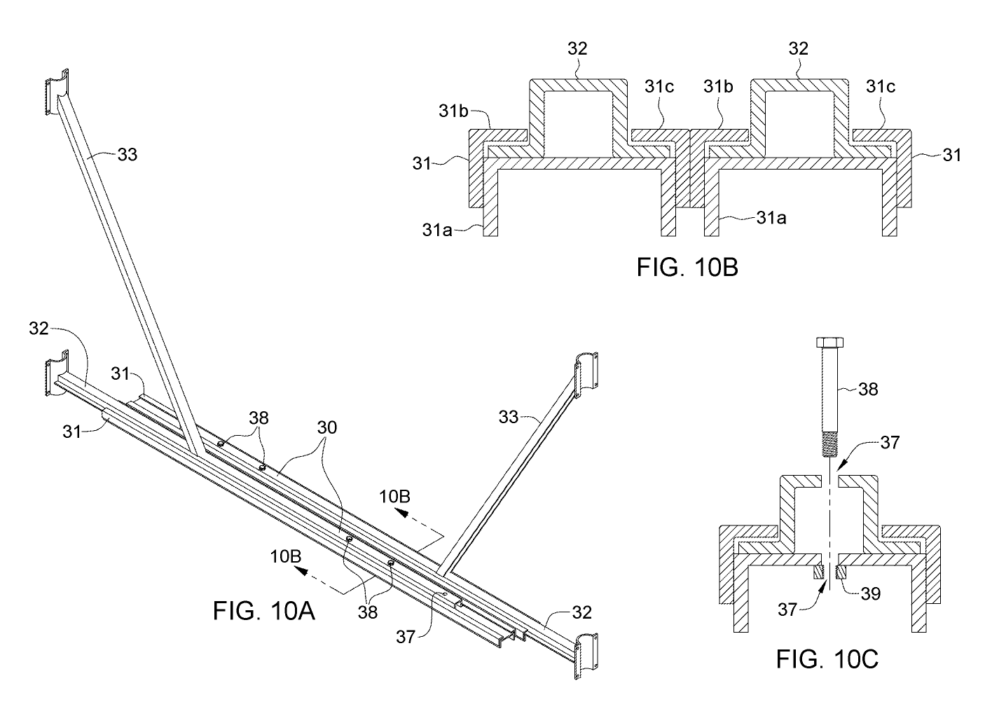

With further reference to FIGS. 10A-10B, in a preferred embodiment, guide rail 31 comprises base member 31a and retainer members 31b fixedly attached thereto forming channels for slidably receiving slide rail 32 in the longitudinal direction and retaining the slide rail in transverse directions. Slide rail 32 is disposed in said channels and in the space between retainer members 31b. The slide rail is slidable longitudinally in said channels and space and retained transversely therein by member 31a and members 31b. In embodiments having a driver side and passenger side spray bar, each bar may be mounted to a different slide rail mount, and said the guide rails thereof may be connected side-by-side as in FIGS. 9A, 10A and 10B.

With further reference to FIG. 10A-10C, the slide rail mount 30 may be provided with a means for releasably fixing slide rail 32 to guide rail 31 in the desired position. The position of the slide rail may be releasably secured by tightening said means. Said means may be loosened to allow repositioning of the slide rail and re-tightened to fix the slide rail in the new position. With reference to FIGS. 10A-10C, in a preferred embodiment, guide rail base member 31a and slide rail 32 may be provided with a plurality of holes 37 spaced apart along the longitudinal direction of the slide rail assembly for receiving a rod, pin, bolt or other fastener 38. Slide rail 32 may be slid into position so as to align one or more of its holes 37 with one or more of the guide rail holes 37, and one or more fasteners 38 may be inserted through the aligned holes, thus preventing further sliding of the slide rail relative to the guide rail. Base member 31a may be provided with female-threaded member 39 for receiving the bolt threads. Said threaded member may a be a nut, which may be welded to the base member. For example, a bolt may be inserted through the aligned holes and threaded to threaded member 39 so as to tighten the slide rail and guide rail together. Threaded member 39 may be a separate nut, which may be tightened onto exposed bolt threads beneath base member 31a.

With further reference to FIGS. 6. 9, 9A and 9B, slide rails 32 and uprights 33 may have u-bracket mounts 34 at the end for receiving spray bars 10. Spray bar 10 may be releasably connected to slide rail 32 and upright 33 with a connection comprising u-bracket mounts 34, releasable u-bracket clamps 35, and clamp fasteners 36. U-bracket mounts 34 and u-bracket clamps 35 may have holes for receiving fasteners 36. In one embodiment, said u-bracket holes may be threaded for receiving fastener 36 threads, and in another embodiment the u-bracket holes may be without threads and a nut may be provided for receiving fastener 36 threads. Vertical positioning of spray bar 10 may be adjustable. Vertical adjustment of the spray bar may be accomplished by loosening or removing clamps 35, then changing the vertical position of the spray bar, then tightening the clamps around the spray bar to hold it in the new vertical position.

Any suitable means may be used to mount a spray bar to the vehicle. Spray bar mounts may be attached to the chassis or frame of the vehicle anywhere along the length of the vehicle, such as adjacent to the tank, between the tank and cab, adjacent to the cab, and forward of the cab. “Chassis” and “frame” are used interchangeably in this disclosure. Spray bar mounts may be adapted and configured as necessary to be compatible with and attachable to the structure of the vehicle at the attachment location. The mounts need not be slidable or adjustable.

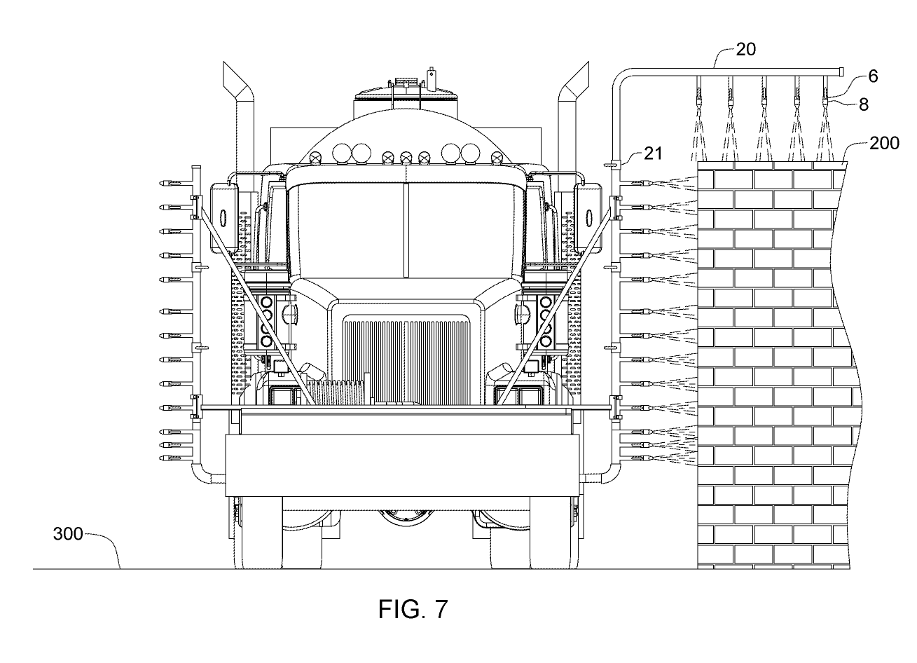

With reference to FIG. 7, the improved flusher system may further comprise spray bar extension 20 connected to spray bar 10. In one embodiment, spray bar extension 20 comprises multiple spray nozzles 8 and nozzle valves 6. Each valve may have a valve handle. The connection 21 between extension 20 and spray bar 10 may comprise a cam and groove coupling, also called a cam lock fitting or cam lever coupling, for quick and easy connection and disconnection. Connection 21 may further comprise a shut off valve with a valve handle for manually opening and closing the valve. Once spray bar extension 20 is connected to spray bar 10, it may be activated for spraying by opening valve 21 and deactivated by closing the valve.

In a preferred embodiment, spray bar extension 20 is attached to the top of spray bar 10, extends outwardly away from the truck, and is configured so as to direct spray downward. Downwardly directed spray may be used to spray upward-facing surfaces of a roadside structure or other object. In alternate embodiments, the spray bar extension may be configured and positioned so as to direct spray in other directions, for example, in an upward direction to spray downwardly facing surfaces of an overhead object, or configured and positioned to direct spray in any direction or multiple directions simultaneously. In another embodiment, the spray bar extension may have a downward projection at its outer end, which downward projection may have nozzles aimed inward towards the truck for spraying the back side of the object.

With reference to FIG. 6, tank 92 supplies water to water pump 51. In a preferred embodiment, the water pump is a high-pressure water pump. The water pump pumps water to spray devices through a distribution system comprising water lines, fixtures and control valves, which may be high-pressure lines, fixtures and control valves in a preferred embodiment. The spray devices comprises at least one spray bar 10. In a preferred embodiment, the spray devices comprises a left side (or driver side) spray bar and right side (or passenger side) spray bar. The spray devices may also comprise a front hose reel 95 and front hose 96 and a rear hose reel 97 and rear hose 98.

Hose reels 95 and 97 may be motorized for winding and unwinding. Said hose reels may comprise an electric motor that turns the reels for winding and unwinding the hoses.

In the embodiment of FIG. 6, water flows from tank 92 to water pump 51 via supply line 60. Pump 51 pumps water through line 61 to tee 62. In a preferred embodiment, the pump pumps water at high pressure. Tee 62 divides the flow into three branches, namely to driver side spray bar 10, passenger side spray bar 10 and to front hose reel 95. Each branch of the tee may be fitted with a solenoid control valve 54. In preferred methods of operation, only one of the tee control valves 54 is open during spraying operations, but in other methods multiple valves may be open simultaneously. Driver side spray bar 10 is connected to the tee via hose 63, and passenger side spray bar 10 is connected to the tee via hose 64. In a preferred embodiment, hoses 63 and 64 are high-pressure hoses.

The water distribution system further comprises water distribution line 65 to front hose reel 95 and line 66 to rear hose reel 97. Lines 65 and 66 may each be fitted with a solenoid valve 55. In a preferred embodiment, distribution lines 65 and 66 may be 1-inch diameter high-pressure lines and may carry flow rates of 15 gpm at a pressure of 100 pounds per square inch (“psi”).

With further reference to FIG. 6, The pressurized water distribution system further comprises a bypass valve 52 and bypass line 67. The bypass valve is situated on the discharge side of pump 51. During spraying operations, pressurized water flows from the pump through the bypass valve into main distribution line 61 for distribution to system spray devices. The bypass valve operates automatically to maintain system water pressure below a predetermined threshold. Bypass valve 52 automatically bypasses enough of the water flow through bypass line 67 into tank 92 to keep system pressure below the threshold pressure. The bypass valve is adjustable so that the predetermined threshold pressure may be set at desired values. For example, the bypass valve may be set at 112 psi. For example, the bypass valve may be set at a pressure based on the maximum allowable pressure to any of the system components. The bypass valve protects pump 51 and other components from damage due to excessive pressure or insufficient flow such as may occur when all spray devices are closed while the pump is running. In other embodiments, the bypass valve may be triggered based on minimum flow rates needed for pump cooling to prevent pump overheating.

In a preferred embodiment, control valves 53, 54 and 55 may be solenoid valves. Said control valves may have valve handles for manually opening and closing the valves.

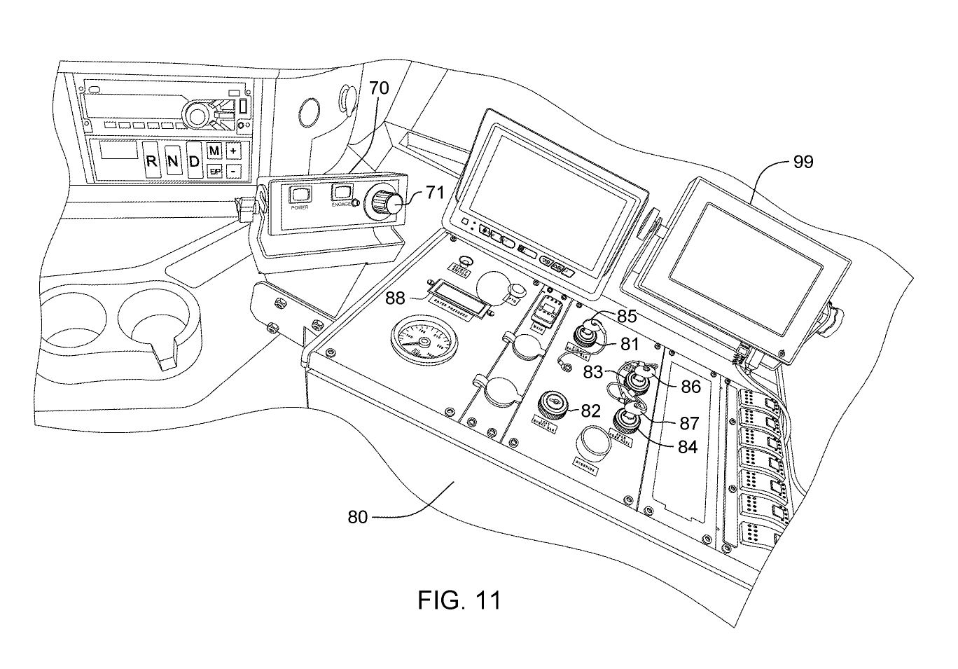

With reference to FIG. 11, solenoid control valves may electronically controlled by an operator through a control panel 80 mounted in the cab of the truck. In a preferred embodiment, solenoid valves are placed so that flow to each spray device (for example, hoses and spray bars) in the distribution system may be opened or closed or otherwise controlled. In a preferred method of operation, flow is opened to only one spray device at a time. In other methods of operation, flow is allowed to more than one spray device simultaneously.

With reference to FIGS. 1, 2, 5 and 6, in a preferred embodiment, the water distribution system comprises high-pressure water pump 51 mounted on rear platform 93, a 3″ diameter line 61 running under the truck from pump 51 to a 2″ diameter tee. A driver side branch of the tee feeds the driver side spray bar 10 and a passenger side branch feeds the passenger side spray bar 10. The connection between the driver side and passenger side branches of the tee and the corresponding spray bar comprises high-pressure hoses 63 and 64, respectively. In one embodiment, said connection may comprise a single hose for the entire range of spray bar positions from fully retracted to fully extended, and in an alternate embodiment said connection may comprise a plurality of different length hoses for specific spray bar positions or ranges of positions. For example, the driver side connection may comprise a first hose 63 when the spray bar is in the fully retracted position, and may comprise a second hose 63 that is longer than said first hose when the spray bar is in the fully extended position.

The coupling between components of the present invention, such as between spray bar sections 2, between spray bar hose 63 and spray bar 10, between spray bar hose 63 and tee 62, between spray bar 10 and spray bar extension 20, or between other components may comprise a cam and groove coupling, also called a cam lock fitting or cam lever coupling, for quick and easy connection and disconnection.

With reference to FIG. 11, in a preferred embodiment, the flushing system of the present invention may be controlled from the cab of the truck using hydraulic pump motor control panel 70 and water distribution system control panel 80. Pump motor control panel 70 may comprise a master power switch for turning panel 70 on and off, an engage switch to enable the control panel to control the speed of the hydraulic motor 44, set point dial 71 for setting the motor speed and an LED for signaling when the power and engage switches are on.

With further reference to FIG. 6, high-pressure water pump 51 is coupled to and driven by hydraulic motor 44. Water pump speed, and therefore water pressure and flow through the water distribution system, is increased by increasing hydraulic motor speed. Thus, spray pressure and flow rate through spray nozzles may be controlled by controlling the hydraulic motor.

With further reference to FIG. 11, set point dial 71 may be turned to any position between a lowest and a highest setting, inclusively, resulting in a corresponding range of water pressure and flow rate from lowest to highest pressure and flow rate through spray nozzles. Dial 71 may be marked with indices so that it may be set at desired positions that correspond to predetermined system performance metrics, such as, for example, pump motor speed, water pressure and water flow rate.

For example, higher settings for dial 71 may maintain desired system pressure when higher flow rates are needed, and lower settings may maintain desired pressure when lower flow rates are needed. Higher settings may maintain desired pressure when more nozzles are activated on spray bar 10, and lower settings may maintain desired pressure when fewer nozzles are activated. Higher settings may be required when multiple spray devices are activated and lower settings may be required when fewer spray devices are activated. Higher settings may be required for operating a spray bar with multiple activated nozzles and lower settings may be required for operating a single hose. For example, there may be indices marking a dial 71 setting that corresponds to water pump output of 30 gpm for spraying operations using front and rear hoses 96 and 98, and separate indices for 200 gpm for full spray bar spraying. The system operator may monitor water system pressure on pressure gauge 88 on control panel 80.

Alternative embodiments may use any commercially available water pump suitable for mounting on a vehicle and providing water pressure and flow for spraying operations.

With further reference to FIG. 11, in a preferred embodiment, water distribution system control panel 80 comprises switch 81 for opening and closing a passenger side spray bar valve 54 (FIG. 6), switch 82 for opening and closing a driver side spray bar valve 54 (FIG. 6), switch 83 for opening and closing a front hose valve 52 (FIG. 6), and switch 84 for opening and closing a rear hose valve 55 (FIG. 6). Switches 81, 82, 83 and 84 are key-operated switches. The system further comprises key 85 for operating spray bar switches 81 and 82, key 86 for operating switch 83, and key 87 for operating switch 84. In a preferred embodiment shown in FIG. 11, passenger and driver side spray bar switches may be operated with the same key so as to discourage or prevent distribution of fluid to more than one spray bar at a time. In a preferred embodiment, switches 81 and 82 and key 85 may be designed so that the switch may not be in the on position without the key inserted, and so that the key may not be removed from a switch unless the switch is turned to the off position.

In a preferred embodiment, solenoid valve 53 to main distribution line 61 may be opened upon turning on the master power switch of control panel 70.

Control panel 80 further comprises a water pressure gauge 88 for monitoring the water pressure in the pressurized water distribution system, a hydraulic fluid temperature gauge, a main power switch, a safety switch indicator light, a power takeoff (PTO) indicator light, and an override button. Water pressure gauge 88 may take readings from a pressure sensor disposed in the water pump discharge flow, such as in the discharge manifold.

The system is operational over a range of vehicle speeds, water pressures and water flow rates. The system generates sufficient fluid pressure and flow rates to flush soluble salts, other contaminants, and other substances off of the object being sprayed. By way of example and not limitation, one set of operational parameters may comprise a vehicle speed of about 3 mph, crankshaft speed of about 600 rpm, power takeoff output speed of about 1150 rpm, and water flow rate of 200 gpm at 100 psi. For example, under normal operating conditions, flow rates may range from 15 gpm-300 gpm over a range of system pressures of 50 psi-110 psi. Spray from spray bars 10 may be functional over a range of zero to more than 10 feet laterally from the bar.

With further reference to FIG. 11, in a preferred embodiment, the improved system of the present invention further comprises a touch screen control panel 99 for controlling signboard 94 (see FIG. 1).

With reference to FIGS. 4A and 7, in a preferred embodiment of the improved flushing system of the present invention, object 200 may be sprayed by driving vehicle 90 alongside the object while fluid 9 is sprayed through driver side spray bar 10.

Positioning the spray bar proximate to the cab promotes safety and effectiveness of the system by providing a closer and better line of sight to the operator in the cab. Positioning the spray bar proximate to the cab allows for closer observation and more precise positioning of the spray bar relative to the object, which positioning may be controlled by steering the vehicle, adjusting the position of slide rail 32 within the guide rail 31 (see FIG. 9A), or both. Positioning the spray bar forward of the cab allows the operator to keep his eyes forward and to watch the road for safe navigation and simultaneously monitor the position of the spray bar relative to the object for efficient spraying operations.

A component that is described as “forward” or “rearward” of another component on a vehicle may also be offset laterally (i.e., in the side-to-side direction of the vehicle) so that it is not directly in line with the other component in the forward and back direction of the vehicle. For example, a spray bar positioned forward of the tank and rearward of the cab (i.e. between the tank and the cab) may be positioned laterally outward beyond the width of the tank or cab.

Fluid may be sprayed through any combination of spray devices, such as any combination of the four spray devices (driver side spray bar, passenger side spray bar, front hose, and rear hose) in the preferred embodiment of FIGS. 1-10. Control panel 80 (see FIG. 11), may be designed so as to allow any combination of switches 81, 82, 83 and 84 to the turned on simultaneously. For example the four switches may be all off, all on, or on in the following combinations where numerals 1, 2, 3 and 4 represent the four switches and the bracket pairs enclose a subset of switches in the on position simultaneously: {1}, {2}, {3}, {4} {1,2}, {1,3}, {1,4}, {2,3}, {2,4}, {3,4}, {1,2,3}, {1,2,4} {1,3,4}, and {2,3,4}. Alternatively, control panel 80 may be designed to restrict the switches from being on in any one or more of the foregoing combinations. For example, the control panel may be so designed as to prevent simultaneous activation of the driver side spray bar and passenger side spray bar, so that only one spray bar may be used for spraying at a time.

With reference to FIG. 6, in a preferred embodiment of the improved flushing system of the present invention, flow control valves 54 (driver side), 54 (passenger side), 55 (front) and 55 (rear), may each be controlled between the fully open position and fully closed position. With reference to FIGS. 4A, 7 and 8, any combination of nozzles 8 may be activated by controlling valves 54, 3, 6 and 21. For example, to activate only the nozzles adjacent to the object targeted for flushing shown in FIG. 4 (the “selected valves”), driver side valve 54 is open, valves 6 of the selected valves are open, and lowermost section valve 3 is closed. As another example illustrated in FIG. 7, driver side valve 54, both section valves 3, extension bar valve 21, and all nozzle valves 6 may be in the open position so that all nozzles 8 are activated. With further reference to FIG. 8, each nozzle 8 in the preferred embodiments of FIGS. 1-10 is individually valved, i.e., has a corresponding nozzle valve 6 and nozzle valve handle 7. Each nozzle 8 is individually selectable and controllable, i.e., each nozzle may be manually controlled individually and independently using its corresponding nozzle valve handle. In an alternate embodiment, the nozzle valves may be solenoid valves that are controllable from a control panel in the cab of the vehicle.

In a preferred method of operation, one may identify the roadside structures or other objects accessible by motor vehicle to be sprayed. One may determine whether the object will be approached on the driver side, passenger side, front or back of the vehicle. One may identify the spray device or devices to be used for spraying. One may open the solenoid valves that controls fluid flow to the identified spray devices, and may do so using the solenoid valve switches on the control panel in the cab of the vehicle. One may close the solenoid valves to the spray devices that are not identified for use, and may do so using the appropriate switches on the control panel in the cab. If a spray bar 10 is identified for use, one may identify which of the spray nozzles 8 are to be used for spraying based on the shape and size of the objects to be sprayed or the shape and size of an area on the objects to be sprayed. One may activate the identified nozzles by opening and closing the appropriate valves 3 and 6 using the corresponding valve handles 4 and 7, respectively.

Alternately, one may leave open the solenoid valves to spray devices that are not identified for use, provided that the nozzle valves of the spray devices are closed. For example, if front hose 96 is not identified for use, solenoid valve 54 for that hose may be in the open position as long as the nozzle valve at the end of the hose is not open. Likewise, if a spray bar 10 is not identified for use, the solenoid valve 54 for that spray bar may be in the open position as long as flow is shut off to the spray bar nozzles 8 by either closing all of the nozzle valves 6 or closing an appropriate combination of nozzle valves and section valves 3.

If, for example, a spray bar 10 is identified for use, one may identify nozzles that are at vertical elevations most closely corresponding to the vertical span of the object to be sprayed and may choose to not identify all other nozzles so that water resources are most efficiently used and unnecessary spraying is avoided. The spray pattern from the spray bar may be thusly adjusted to conform to the size, shape and position of the object to be sprayed. Further adjustment of the spray pattern may be accomplished by aiming any one or more of the nozzles at downward or upward angles. For example, to clean surfaces at or near ground level, the lowermost nozzle or nozzles may be aimed at a downward angle. Spray bar 10 therefore has a variable spray pattern, i.e., the bar can provide various spray patterns by opening and closing section valves 3, opening and closing nozzle valves 6, directing the aim of selected nozzles 8, nozzle replacement to install nozzles having desired spray fan shape, controlling water pressure, and any combination of the foregoing. The selected nozzles work cooperatively to spray the object.

The vertical positioning of a spray bar may be adjusted by loosening the spray bar attachment means, resetting the spray bar at a desired elevation, and then tightening the attachment means to hold it in the desired elevation. Spray bar extensions may also be attached to the top of a spray bar to reach higher elevations.

Elevated upwardly facing surfaces may be sprayed by attaching to the top of a spray bar an outwardly extending spray bar extension having downwardly aimed nozzles.

If no nozzle downstream of a section valve 3 is identified for use, then the valve may be closed using valve handle 4, and individual nozzle valves 6 for the nozzles downstream of the closed section valve may be in either the opened or closed position. Alternatively, if no nozzle downstream of a section valve 3 is identified for use, all individual nozzle valves 6 for the nozzles downstream of the section valve may be closed and the section valve 3 may be in either the opened or closed position.

If one or more nozzles downstream of a section valve are identified for use, then the section valve is opened and nozzle valves 6 are opened for the nozzles identified for use and nozzle valves 6 are closed for the other nozzles.

For nozzles that are not identified for use and for which there is no section valve situated upstream thereof (e.g., the lower six nozzles of FIG. 8), nozzle valve 6 is closed.

For any spray device identified for use, the device may be activated by opening a corresponding control valve, for example driver side control valve 54 may be opened if driver side spray bar 10 is identified for use; and passenger side control valve 54 may be opened if passenger side spray bar 10 is identified for use; and front control valve 55 may be opened if front hose 96 is identified for use; and rear control valve 55 may be opened if rear hose 98 is identified for use.

For any spray device not identified for use, the device may be deactivated by closing a corresponding control valve, for example driver side control valve 54 may be closed if driver side spray bar 10 is not identified for use; passenger side control valve 54 may be closed if passenger side spray bar 10 is not identified for use; front control valve 55 may be closed if front hose 96 is not identified for use; and rear control valve 55 may be closed if rear hose 98 is not identified for use. Alternatively, for a spray device not identified for use, the corresponding control valve may be opened, in which case: for a spray bar 10, section valves 3 and individual nozzle valves 6 may be closed; and for front hose 96, hose nozzle 96a may be closed; and for rear hose 98, hose nozzle 98a may be closed.

In a preferred embodiment of the present invention, spraying operations may be performed entirely from within the cab of the vehicle. The operator drives the vehicle in driving mode at normal driving speeds to the location of the object. Once at the desired location, the operator engages the pump using control panel 70. For spraying objects with a spray bar, the operator drives the truck alongside the object while the pump is engaged and the spray bar is spraying. In a preferred method, the operator drives slowly, for example 3 mph. Preferably, the operator drives the truck so that the spray bar is maintained within 10 feet of the object. A trailing vehicle may be driven at a distance behind the flusher truck, for example 100 to 200 yards behind the flusher truck, which trailing vehicle may be equipped with a rear-facing signboard and rear-end impact cushion for absorbing energy in a collision by an approaching vehicle.

With reference to FIGS. 6, 10A and 10B, the lateral position of the spray bar may be adjusted by sliding slide rail 32 within guide rail 31. For example, the spray bar may be positioned outward beyond the width of the truck to place it within desired range of the object.

To spray objects on the driver side of the truck with corresponding spray bar 10, the operator opens driver side solenoid valve 54. In a preferred embodiment, the valve is opened by inserting Key 85 into switch 82 and turning the switch to the valve-open position. Spray intensity may be adjusted using dial 71 on control panel 70 to adjust power to the water pump. For example, in order to maintain desired spray intensity on an object over a range of distances, the operator may increase spray pressure and flow rate by increasing power to the water pump for larger distances, and may decrease power for smaller distances.

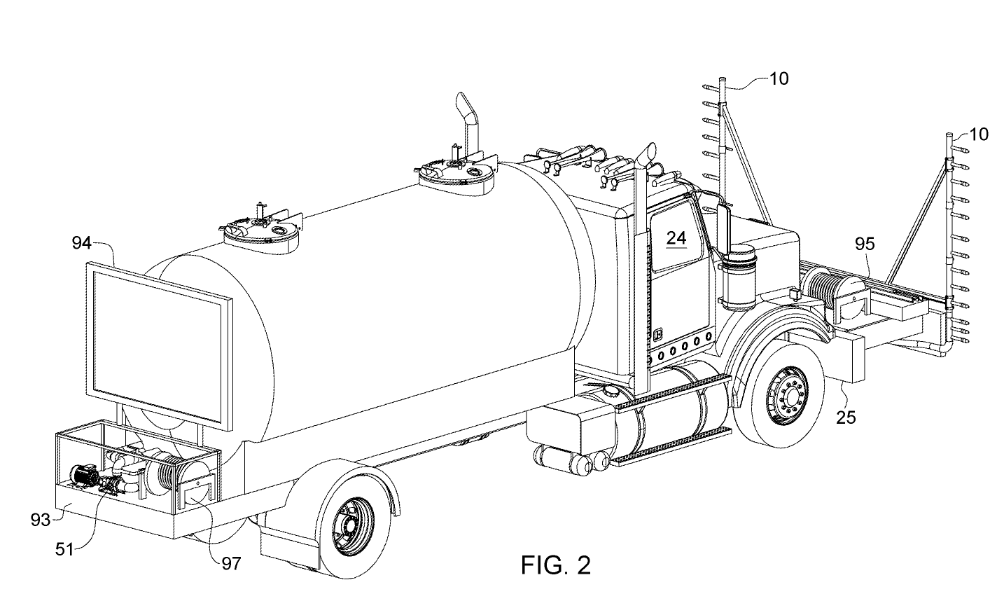

With reference to FIGS. 2 and 11, signboard 94 may be an electronic signboard comprising an matrix of lights or LED's that illuminate selectively to form illuminated traffic safety messages. Signboard 94 may be an LED variable message sign. Examples of traffic safety messages may include various text messages, graphics and arrow patterns, arrows directing traffic to one side or other of the vehicle, arrows indicating lane closure, caution symbols, no passing symbols, flashing lights, “keep left”, “keep right”, preprogrammed messages, and any message or symbol. The signboard is connected in an electronic circuit with controller 99 mounted in the cab. Controller 99 may be a touch screen controller. The operator controls the signboard using controller 99. Controller 99 may comprise a liquid crystal display monitor and may display the signboard message.

Vehicle 90 may also be equipped with emergency flashing light beacons connected to electronic controls in the vehicle cab for controlling the light beacons.

With reference to FIG. 6, hoses 96 and 98 may be operated by a work crew on foot. In one embodiment, hose reels 95 and 97 are mechanized with a motor for turning the reels to wind and unwind the hoses. In another embodiment, the hose reels may be manually wound and unwound. The hoses may be extended, positioned and aimed in any direction as the operator desires.

While the invention has been particularly shown and described with reference to certain embodiments, it will be understood by those skilled in the art that various changes in form and details may be made to the invention without departing from the spirit and scope of the invention as described in the following claims.

We claim:

1. An apparatus for spraying roadside objects with fluid, comprising:
a motor vehicle comprising a cab;
a tank for holding a supply of fluid;
a fluid pump for pumping the fluid; and
a first spray device comprising a first upright spray bar attached to the vehicle for spraying fluid;
wherein the first spray bar comprises a plurality of spaced apart spray outlets and a valve for controlling fluid flow to at least one of the plurality of outlets.

2. The apparatus of claim 1, wherein the valve controls fluid flow to more than one of the plurality of outlets.

3. The apparatus of claim 1, wherein the valve controls fluid flow to a single outlet.

4. The apparatus of claim 1, wherein the first spray bar comprises a main tube and the valve is positioned in the main tube so as to control passage of fluid at the valve location.

5. The apparatus of claim 1, wherein one or more of the plurality of spray outlets comprises a valve for controlling the passage of fluid flow through the outlet to which said valve is connected.

6. The apparatus of claim 1, wherein two or more of the plurality of spray outlets each comprise a valve for controlling the passage of fluid flow through the outlet to which said valve is connected.

7. The apparatus of claim 1, wherein each of the plurality of spray outlets comprises a valve connected thereto for controlling the passage of fluid flow through the outlet to which said valve is connected.

8. The apparatus of claim 1, wherein the first spray bar is adjustably mounted to the vehicle so as to be adjustable laterally over a range of positions.

9. The apparatus of claim 1, wherein the first spray bar is adjustably mounted to the vehicle so the elevation of the spray bar is adjustable over a range of elevations.

10. The apparatus of claim 1, further comprising:
a fluid distribution line for carrying fluid flow to the first spray device; and
a first valve in the distribution line for controlling passage of fluid flow to the spray device.

11. The apparatus of claim 10, wherein the valve is a solenoid valve and the apparatus further comprises:
a controller in the cab for controlling the solenoid valve.

12. The apparatus of claim 1, further comprising:
a second spray device;
a fluid distribution line for carrying fluid flow to the first and second spray devices, said line having a first branch for carrying fluid to the first spray device and a second branch for carrying fluid to the second spray device;
a first valve for controlling passage of fluid flow to the first spray device; and
a second valve for controlling passage of fluid flow to the second spray device.

13. The apparatus of claim 12, wherein:
the second spray device comprises a second upright spray bar attached to the vehicle for spraying fluid;
said second spray bar comprising a plurality of spaced apart spray outlets.

14. The apparatus of claim 13, wherein one of the spray bars is disposed on the driver side of the vehicle and the other spray bar is disposed on the passenger side.

15. The apparatus of claim 12, wherein at least one of the first and second valves is a solenoid valve and the apparatus further comprises:
a control panel mounted in the cab for controlling the solenoid valve.

16. An apparatus for spraying roadside objects with fluid, comprising:
a motor vehicle comprising a cab;
a tank for holding a supply of fluid;
a fluid pump for pumping the fluid; and
a spray device comprising an upright spray bar for spraying fluid, said spray bar disposed forward of at least part of the tank;
wherein said spray bar comprises a plurality of spaced apart spray outlets.

17. The apparatus of claim 16, wherein the spray bar is disposed forward of the tank.

18. The apparatus of claim 16, wherein the cab comprises a side window and the spray bar is disposed forward of at least part of the side window.

19. The apparatus of claim 16, wherein the spray bar is disposed forward of the cab.

20. The apparatus of claim 16, wherein the spray bar is adjustably mounted to the vehicle so as to be adjustable laterally over a range of positions.

21. The apparatus of claim 16, further comprising:
a rearward facing electronic signboard mounted on the truck for displaying traffic safety information; and
a controller in the cab for controlling an electronic signboard.

22. The apparatus of claim 11, further comprising a spray bar extension attached to the spray bar, the extension configured so as to spray fluid downwardly for spraying an upwardly facing surface of the object.

23. An apparatus for spraying roadside objects with fluid, comprising:
a motor vehicle comprising a cab;
a tank for holding a supply of fluid;
a fluid pump for pumping the fluid; and
a plurality of individually valved spray outlets spaced apart at different elevations for spraying the object.

24. The apparatus of claim 24, wherein the plurality of nozzles are forward of the tank.

25. The apparatus of claim 24, wherein the plurality of nozzles are forward of the cab.

26. An apparatus for spraying roadside objects with fluid, comprising:
an elongated conduit for carrying pressurized fluid flow;
a plurality of individually valved spray outlets for spraying the object, said plurality of outlets spaced apart in the lengthwise direction of the conduit;
wherein each valve of each of said plurality of outlets is independently operable.

27. A method of spraying an object, comprising:
propelling the apparatus of claim 1 alongside an object and simultaneously spraying fluid from the apparatus at the object.

28. A method of spraying an object, comprising:
propelling the apparatus of claim 16 alongside an object and simultaneously spraying fluid from the apparatus at the object.

29. A method of spraying an object, comprising:
propelling the apparatus of claim 23 alongside an object and simultaneously spraying fluid from the apparatus at the object.

30. A method of spraying an object, comprising:
providing a vehicle equipped with a plurality of individually selectable spray nozzles that are spaced apart at different elevations;
selecting one or more of said spray nozzles; and
propelling the vehicle alongside the object while simultaneously spraying fluid from the selected spray nozzles at the object.

31. The method of claim 29, wherein:
the vehicle provided in the providing step further comprises a rearward facing traffic safety signboard; and
the method further comprises displaying a traffic safety message on the signboard while simultaneously spraying fluid from the elected spray nozzles.
